(19) United States
(12) Patent Application Publication
(10) Pub. No.: US 2025/0314766 A1
(43) Pub. Date: Oct. 9, 2025

(54) UNDERWATER MOTION TRAJECTORY GENERATION METHOD, SYSTEM, TERMINAL, AND STORAGE MEDIUM

(71) Applicant: Guangdong COROS Sports Technology Joint Stock Company, Dongguan (CN)

(72) Inventors: Haotian NIU, Dongguan (CN); Ning ZHANG, Dongguan (CN); Hongbo XU, Dongguan (CN); Kai CHEN, Dongguan (CN)

(21) Appl. No.: 18/961,232

(22) Filed: Nov. 26, 2024

Related U.S. Application Data
(63) Continuation of application No. PCT/CN2022/099157, filed on Jun. 16, 2022.

(51) Int. Cl. G01S 15/66; G01S 7/62

(52) U.S. Cl. CPC G01S 15/66; G01S 7/62

(57) ABSTRACT

Provided are a method for generating an underwater motion trajectory, a system, a terminal and a storage medium. The method may be applied to a sonar system. The sonar system includes a first mobile terminal carried by a user and a sonar device located on the water surface. The method includes: controlling the first mobile terminal to send a first sound wave signal; controlling the sonar device to send a second sound wave signal in response to the sonar device receiving the first sound wave signal; controlling the first mobile terminal to generate an underwater motion trajectory of the user according to the first sound wave signal and the second sound wave signal.

### CROSS-REFERENCE TO RELATED APPLICATION

This is a continuation of International Patent Application No. PCT/CN2022/099157, filed Jun. 16, 2022, and the disclosure of which is incorporated herein by reference in its entirety.

### TECHNICAL FIELD

The present application relates to the field of terminals, for example, to a method for generating an underwater motion trajectory, a system, a terminal and a storage medium.

### BACKGROUND

Mobile terminals such as smartwatches and smart bracelets have been widely used for recording users' health and motion data, for example, recording running and cycling motion trajectories. Generally, the mobile terminals use Global Positioning System (GPS) satellite positioning apparatuses to achieve real-time positioning and record motion trajectories. However, when the users engage in underwater sports such as diving, since satellite positioning signals cannot be received underwater, this manner cannot be used for recording motion trajectories.

### SUMMARY

The present application provides a method for generating an underwater motion trajectory, a system, a terminal and a storage medium.

According to an aspect of the present application, a method for generating an underwater motion trajectory is provided. The method is applied to a sonar system, where the sonar system includes a first mobile terminal carried by a user and a sonar device located on a water surface; and the method includes the steps below.

The first mobile terminal is controlled to send a first sound wave signal.

The sonar device is controlled to send a second sound wave signal in response to the sonar device receiving the first sound wave signal.

The first mobile terminal is controlled to generate an underwater motion trajectory of the user according to the first sound wave signal and the second sound wave signal.

According to another aspect of the present application, a method for generating an underwater motion trajectory is provided. The method is applied to a first mobile terminal carried by a user in a sonar system, where the sonar system further includes a sonar device; and the method includes the steps below.

The first mobile terminal is controlled to send a first sound wave signal.

A second sound wave signal is received to generate an underwater motion trajectory of the user according to the first sound wave signal and the second sound wave signal, where the second sound wave signal is sent by the sonar device in response to the received first sound wave signal.

According to another aspect of the present application, a sonar system is provided. The sonar system includes a first mobile terminal carried by a user and a sonar device located on a water surface and further includes at least one processor. The at least one processor is configured to perform the steps below.

The first mobile terminal is controlled to send a first sound wave signal.

The sonar device is controlled to send a second sound wave signal in response to the sonar device receiving the first sound wave signal.

The first mobile terminal is controlled to generate an underwater motion trajectory of the user according to the first sound wave signal and the second sound wave signal.

According to another aspect of the present application, a first mobile terminal of a sonar system is provided. The first mobile terminal is carried by a user, the sonar system further includes a sonar device located on a water surface, and the first mobile terminal includes at least one processor. The at least one processor is configured to perform the steps below.

The first mobile terminal is controlled to send a first sound wave signal.

A second sound wave signal is received to generate an underwater motion trajectory of the user according to the first sound wave signal and the second sound wave signal, where the second sound wave signal is sent by the sonar device in response to the received first sound wave signal.

According to another aspect of the present application, a non-transitory computer-readable storage medium is provided. The non-transitory computer-readable storage medium stores computer instructions which, when executed by a processor, are configured to cause the processor to perform the method for generating an underwater motion trajectory according to any one of embodiments of the present application, where the method is applied to a sonar system.

According to another aspect of the present application, a non-transitory computer-readable storage medium is provided. The non-transitory computer-readable storage medium stores computer instructions which, when executed by a processor, are configured to cause the processor to perform the method for generating an underwater motion trajectory according to any one of embodiments of the present application, where the method is applied to a first mobile terminal carried by a user in a sonar system.

It is to be understood that the content described in this part is neither intended to identify key or important features of the embodiments of the present application nor intended to limit the scope of the present application. Other features of the present application are apparent from the description provided hereinafter.

### BRIEF DESCRIPTION OF DRAWINGS

To illustrate embodiments of the present application more clearly, drawings used in description of the embodiments are briefly described below. Apparently, the drawings described below illustrate only part of the embodiments of the present application, and those of ordinary skill in the art may obtain other drawings based on the drawings described below on the premise that no creative work is done.

FIG. 1 is a flowchart of a method for generating an underwater motion trajectory according to an embodiment of the present application.

FIG. 2 is a flowchart of a method for generating an underwater motion trajectory according to an embodiment of the present application.

FIG. 3 is a flowchart of a method for generating an underwater motion trajectory according to an embodiment of the present application.

FIG. 4 is a flowchart of a method for sending a second sound wave signal according to an embodiment of the present application.

FIG. 5 is a flowchart of a method for generating an underwater motion trajectory according to an embodiment of the present application.

### DETAILED DESCRIPTION

For a better understanding of technical solutions in the present application by those skilled in the art, embodiments of the present application are described clearly and completely in conjunction with the drawings in the embodiments of the present application. Apparently, the embodiments described below are part, not all, of embodiments. Based on the embodiments in the present application, all other embodiments obtained by those of ordinary skill in the art are within the protection scope of the present application on the premise that no creative work is done.

It is to be noted that the terms such as “first” and “second” in the description, claims and drawings of the present application are used for distinguishing between similar objects and are not necessarily used for describing a particular order or sequence. It is to be understood that data used in this manner are interchangeable where appropriate so that the embodiments of the present application described herein can be implemented in an order not illustrated or described herein. Additionally, terms “including” and “having” or any variations thereof are intended to encompass a non-exclusive inclusion. For example, a process, method, system, product, or device that includes a series of steps or units not only includes the expressly listed steps or units but may also include other steps or units that are not expressly listed or are inherent to such a process, method, product, or device.

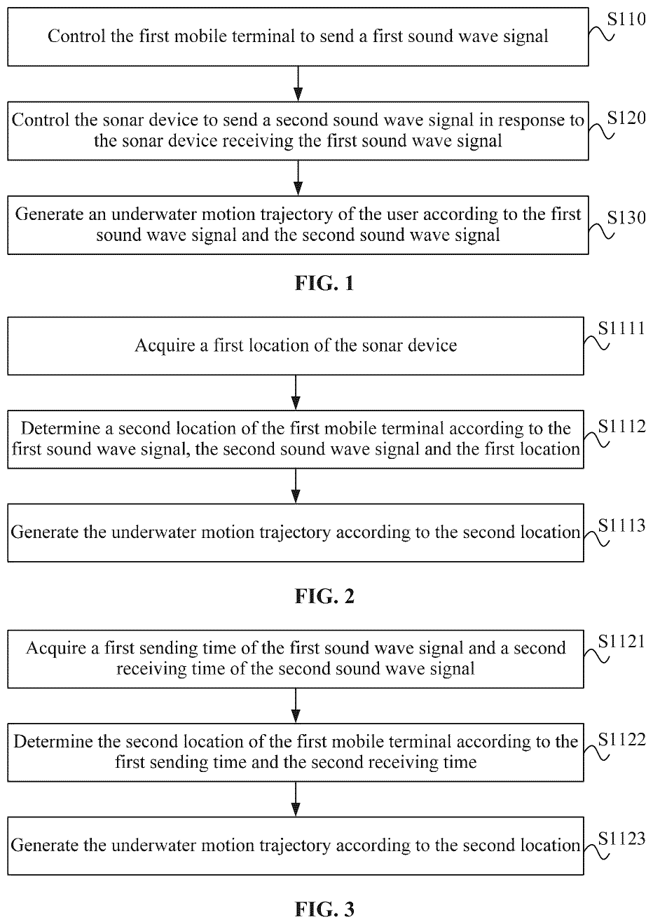

FIG. 1 is a flowchart of a method for generating an underwater motion trajectory according to an embodiment of the present application. This embodiment may record the underwater motion trajectory. The method may be performed by a sonar system. The sonar system may be implemented in the form of hardware and/or software. The sonar system includes a first mobile terminal carried by a user and a sonar device located on the water surface. As shown in FIG. 1, the method includes the steps below.

In S110, the first mobile terminal is controlled to send a first sound wave signal.

The sonar device is a device that uses the propagation and reflection characteristics of sound waves in water to navigate and measure a distance through electro-acoustic conversion and information processing. The first mobile terminal is a mobile device having a sound wave sending function and may be carried by the user. The first sound wave signal may be a sound wave signal sent by the first mobile terminal.

In some embodiments, the method further includes that a working mode of the first mobile terminal is detected, where the working mode of the first mobile terminal includes an underwater mode. That the first mobile terminal is controlled to send the first sound wave signal includes that the first mobile terminal is controlled to send the first sound wave signal in the case where it is detected that the working mode of the first mobile terminal is the underwater mode.

In an embodiment, that the working mode of the first mobile terminal is detected may include that a working mode selection operation of the user is received, and the working mode of the first mobile terminal is determined according to the selection operation of the user. For example, the user may select the working mode (such as the underwater mode or a land mode) by operating a user interface (such as a graphical interface, a joystick, or a button) of the first mobile terminal.

In an embodiment, that the working mode of the first mobile terminal is detected may include that the state of the first mobile terminal is detected, where the state of the first mobile terminal may include being above water or being underwater; the working mode is determined according to the detected state of the first mobile terminal; the working model may be determined as the underwater mode in the case where it is detected that the state of the first mobile terminal is being underwater.

In some embodiments, the state of the first mobile terminal may be determined by detecting whether a positioning apparatus of the first mobile terminal can receive a satellite positioning signal. For example, the satellite positioning apparatus of the first mobile terminal may receive the satellite positioning signal, and when it is detected that the first mobile terminal cannot receive the satellite positioning signal (for example, the first mobile terminal does not receive the satellite positioning signal within a preset duration), the state of the first mobile terminal is determined to be underwater.

In some embodiments, the state of the first mobile terminal may also be determined by detecting a pressure applied to the surface of the first mobile terminal. For example, the pressure applied to the surface of the first mobile terminal may be monitored by a pressure sensor installed on the first mobile terminal. When it is detected that the pressure applied to the surface of the first mobile terminal is greater than a preset pressure threshold (such as the atmospheric pressure), the state of the first mobile terminal is determined to be underwater.

In an embodiment, the first mobile terminal may be a device such as a smartwatch or a smart bracelet that integrates the sound wave sending function and a motion trajectory display function or may also be an independent mobile sound wave sending device. When the user is below the water surface, the sonar system may control the first mobile terminal to send the first sound wave signal to the sonar device.

In S120, the sonar device is controlled to send a second sound wave signal in response to the sonar device receiving the first sound wave signal.

The sonar device has a function of receiving and sending a sound wave signal. The second sound wave signal is a sound wave signal sent by the sonar device.

In an embodiment, after the first mobile terminal sends the first sound wave signal, if the sonar device receives the first sound wave signal, the sonar system, in response to the first sound wave signal, may control the sonar device to send the second sound wave signal.

In S130, an underwater motion trajectory of the user is generated according to the first sound wave signal and the second sound wave signal.

In an embodiment, the positioning of the first mobile terminal may be determined according to the first sound wave signal and the second sound wave signal, and a motion trajectory of the first mobile terminal over a period of time is generated according to positioning data at different moments. Since the user carries the first mobile terminal and is below the water surface, the motion trajectory of the first mobile terminal may be determined as the underwater motion trajectory of the user.

For example, a relative location between a sending location of the first sound wave signal and a sending location of the second sound wave signal may be determined according to receiving times, sending times and sound speeds of the sound wave signals, and if the positioning of the sonar device is known, the positioning of the first mobile terminal may be determined, thereby determining the underwater motion trajectory of the user.

In the method for generating an underwater motion trajectory provided in the embodiment of the present application, the underwater motion trajectory of the user can be generated by using the first mobile terminal carried by the user to send the first sound wave signal to the sonar device.

FIG. 2 is a flowchart of a method for generating an underwater motion trajectory according to an embodiment of the present application and is another possible implementation of the preceding embodiment. As shown in FIG. 2, the method includes the steps below.

In S1111, a first location of the sonar device is acquired.

The first location is collected by a positioning apparatus of the sonar device.

In an embodiment, the sonar device may include the positioning apparatus. The positioning apparatus is configured to acquire the real-time positioning of the sonar device. In an embodiment, the positioning apparatus may be a Global Positioning System (GPS) apparatus located on the water surface and achieve all-weather, continuous and real-time high-precision positioning of the sonar device.

In S1112, a second location of the first mobile terminal is determined according to the first sound wave signal, the second sound wave signal and the first location.

In an embodiment, a relative location between the first mobile terminal and the sonar device may be calculated according to the receiving times, the sending times and the sound speeds of the first sound wave signal and the second sound wave signal, and after the first location of the sonar device is acquired, the second location of the first mobile terminal may be determined according to the first location of the sonar device and the relative location between the first mobile terminal and the sonar device.

In S1113, the underwater motion trajectory is generated according to the second location.

In an embodiment, the second location of the first mobile terminal at different moments may be determined, so a continuous motion trajectory of the first mobile terminal may be generated and used as the underwater motion trajectory of the user.

In some embodiments, the sonar device includes at least two sound wave sending apparatuses, and a manner in which the sonar device is controlled to send the second sound wave signal may be that the at least two sound wave sending apparatuses are controlled to send the second sound wave signal.

In an embodiment, the sonar device may include multiple sound wave sending apparatuses, and the second sound wave signal may be sent by each sound wave sending apparatus separately.

Correspondingly, a manner in which the second location of the first mobile terminal is determined according to the first sound wave signal, the second sound wave signal and the first location may be that a third location of each sound wave sending apparatus is determined according to the first location and an installation location relationship of each sound wave sending apparatus on the sonar device; the second location is determined according to the first sound wave signal, the second sound wave signal sent by the at least two sound wave sending apparatuses and the third locations of the at least two sound wave sending apparatuses.

In an embodiment, the first location of the sonar device may be collected by the positioning apparatus of the sonar device, and the installation location relationship of each sound wave sending apparatus on the sonar device may be determined when the sonar device is produced. After the first location of the sonar device and the installation location relationship of each sound wave sending apparatus on the sonar device are acquired, the third location of each sound wave sending apparatus may also be determined correspondingly.

For example, a rectangular coordinate system is established using the first location of the sonar device as a coordinate origin, and if the sonar device includes two sound wave sending apparatuses, and the two sound wave sending apparatuses are located at two ends of the origin respectively and each have a distance a from the origin, coordinates of the two sound wave sending apparatuses may be (a, 0, 0) and (−a, 0, 0) respectively; if the sonar device includes three sound wave sending apparatuses, and the three sound wave sending apparatuses form three vertices of a right triangle, coordinates of the three sound wave sending apparatuses may be (a, 0, 0), (0, b, 0) and (0, 0, 0) respectively.

In an embodiment, a relative location between the first mobile terminal and each sound wave sending apparatus may be determined according to the receiving times, the sending times and sound speed data of the first sound wave signal, and the second sound wave signal sent by each sound wave sending apparatus, and after the third location of each sound wave sending apparatus is determined, the second location of the first mobile terminal may be calculated correspondingly.

In some embodiments, the sonar device includes at least two sound wave receiving apparatuses, the at least two sound wave receiving apparatuses are configured to receive the first sound wave signal, and a manner in which the sonar device is controlled to send the second sound wave signal in response to the sonar device receiving the first sound wave signal may be that the sonar device is controlled to send the second sound wave signal in response to any sound wave receiving apparatus receiving the first sound wave signal.

In an embodiment, the sonar device may include multiple sound wave receiving apparatuses, and when the any sound wave receiving apparatus receives the first sound wave signal, the sonar device may be controlled to send the second sound wave signal.

Correspondingly, a manner in which the second location of the first mobile terminal is determined according to the first sound wave signal, the second sound wave signal and the first location may be that a fourth location of each sound wave receiving apparatus is determined according to the first location and an installation location relationship of each sound wave receiving apparatus on the sonar device; the second location of the first mobile terminal is determined according to the first sound wave signal, the second sound wave signal and the fourth locations of the at least two sound wave receiving apparatuses.

Similarly, after the first location of the sonar device and the installation location relationship of each sound wave receiving apparatus on the sonar device are acquired, the fourth location of each sound wave receiving apparatus may be obtained correspondingly. A relative location between the first mobile terminal and each sound wave receiving apparatus may be then determined according to the receiving times, the sending times and the sound speed data of the first sound wave signal and the second sound wave signal, and after the fourth location of each sound wave receiving apparatus is determined, the second location of the first mobile terminal may be calculated correspondingly.

In some embodiments, the sonar system includes at least two sonar devices, and the method further includes a step below.

Each sonar device is controlled to receive the first sound wave signal and send the second sound wave signal.

In an embodiment, the sonar system may include multiple sonar devices, and each sonar device may independently receive the first sound wave signal and send the second sound wave signal.

Correspondingly, a manner in which the second location of the first mobile terminal is determined according to the first sound wave signal, the second sound wave signal and the first location may be that the second location of the first mobile terminal is determined according to the first sound wave signal, the second sound wave signal and multiple first locations.

In an embodiment, a first location of each sonar device may be determined according to data collected by a positioning apparatus of each sonar device, and a relative location between the first mobile terminal and each sonar device may be then determined according to the receiving times, the sending times and the sound speed data of the first sound wave signal and the second sound wave signal, so the second location of the first mobile terminal may be calculated.

For example, if the sonar system includes three sonar devices, a rectangular coordinate system is established, and coordinates of the three sonar devices are A (a, 0, 0), B (0, b, 0) and C (0, 0, 0) respectively; distances from the first mobile terminal to the three sonar devices are determined as L₁, L₂ and L₃ according to the receiving times, the sending times and the sound speed data of the first sound wave signal and the second sound wave signal respectively; if a coordinate of the second location of the first mobile terminal is set as M (x, y, z), an equation set may be established:

$$\{ \begin{matrix}{L}_{1}^{2} & = {( a - x )}^{2} + {y}^{2} + {𝓏}^{2} \\ {L}_{2}^{2} & = {x}^{2} + {( b - y )}^{2} + {𝓏}^{2} \\ {L}_{3}^{2} & = {x}^{2} + {y}^{2} + {𝓏}^{2}\end{matrix} ;$$

the coordinate of the second location of the first mobile terminal may be obtained by solving the preceding equation set:

$$\{ \begin{matrix}x & = ( {L}_{3}^{2} - {L}_{1}^{2} + {a}^{2} ) / 2 a \\ y & = ( {L}_{3}^{2} - {L}_{2}^{2} + {b}^{2} ) / 2 b \\ 𝓏 & = \sqrt{{L}_{3}^{2} - {x}^{2} - {y}^{2}}\end{matrix} .$$

In some embodiments, the first mobile terminal may also include multiple sound wave sending apparatuses or multiple sound wave receiving apparatuses; similarly, a distance from the first mobile terminal to the sonar device may be calculated according to the receiving times and the sending times of the first sound wave signal and the second sound wave signal, so the second location of the first mobile terminal is determined according to the first location of the sonar device and the distance from the first mobile terminal to the sonar device.

FIG. 3 is a flowchart of a method for generating an underwater motion trajectory according to an embodiment of the present application and is another possible implementation of the preceding embodiment. As shown in FIG. 3, the method includes the steps below.

In S1121, a first sending time of the first sound wave signal and a second receiving time of the second sound wave signal are acquired.

The first sending time is a time at which the first mobile terminal sends the first sound wave signal. The second receiving time is a time at which the first mobile terminal receives the second sound wave signal. The second sound wave signal is a response signal after the sonar device receives the first sound wave signal.

In an embodiment, for the first mobile terminal, the first sending time corresponding to the first sound wave signal and the second receiving time corresponding to the second sound wave signal may be acquired.

In S1122, the second location of the first mobile terminal is determined according to the first sending time and the second receiving time.

In an embodiment, after the first sending time and the second receiving time are determined, the propagation durations of each sound wave between the first mobile terminal and the sonar device may be obtained, and since the sound speeds are known, the distance from the first mobile terminal to the sonar device may be further obtained. For example, if the sound speeds are each denoted as v, the first sending time is denoted as T₁, and the second receiving time is denoted as T₂, the propagation duration of each sound wave between the first mobile terminal and the sonar device may be (T₂−T₁)/2, and the distance from the first mobile terminal to the sonar device may be that L=V×(T₂−T₁)/2.

Further, the positioning of the sonar device may be obtained through the positioning apparatus, and after the distance from the first mobile terminal to the sonar device is determined, the second location of the first mobile terminal may be calculated in conjunction with the positioning of the sonar device.

In some embodiments, a manner in which the second location of the first mobile terminal is determined may be that a delay duration of the sonar device is acquired, where the delay duration is determined by a first receiving time at which the sonar device receives the first sound wave signal and a second sending time at which the sonar device sends the second sound wave signal; the second location of the first mobile terminal is determined according to the first sending time, the second receiving time and the delay duration.

In an embodiment, a certain delay may exist between the sonar device receiving the first sound wave signal and the sonar device sending the second sound wave signal; in this case, the sound speeds are each denoted as v, the first sending time is denoted as T₁, the second receiving time is denoted as T₂, and the delay duration is denoted as T₃, the propagation duration of each sound wave between the first mobile terminal and the sonar device may be (T₂−T₁−T₃)/2, and the distance from the first mobile terminal to the sonar device may be that L=V×(T₂−T₁−T₃)/2. Subsequently, the second location of the first mobile terminal may be determined according to the positioning of the sonar device and the distance from the first mobile terminal to the sonar device.

In S1123, the underwater motion trajectory is generated according to the second location.

In an embodiment, the second location of the first mobile terminal at different moments may be determined, so a continuous motion trajectory of the first mobile terminal may be generated and used as the underwater motion trajectory of the user.

FIG. 4 is a flowchart of a method for sending a second sound wave signal according to an embodiment of the present application and is another possible implementation of the preceding embodiment. As shown in FIG. 4, the method includes the steps below.

In S1211, a first identifier of the first mobile terminal is acquired.

The first sound wave signal includes the first identifier of the first mobile terminal.

In an embodiment, the first identifier may be at least one type of information among identification information such as an identifier of the first mobile terminal, a sending time of the first sound wave signal and an identifier of the first sound wave signal and may indicate to the sonar device that the first sound wave signal is sent by the first mobile terminal.

In S1212, the sonar device is controlled to send the second sound wave signal according to the first identifier in response to the sonar device receiving the first sound wave signal.

In an embodiment, after receiving the first sound wave signal, according to the first identifier in the first sound wave signal, the sonar device may determine that the first sound wave signal is a sound wave signal sent by the first mobile terminal and may send the second sound wave signal in response to the first sound wave signal.

In some embodiments, the second sound wave signal includes a second identifier of the sonar device, and the method for generating an underwater motion trajectory further includes a step below.

The second identifier is determined according to the first identifier.

The second identifier is generated according to the first identifier and may indicate to the first mobile terminal that the second sound wave signal is sent by the sonar device in response to the received first sound wave signal sent by the first mobile terminal.

In an embodiment, the first mobile terminal may send multiple first sound wave signals, and each second sound wave signal is a response signal to a respective first sound wave signal, so the second identifier may be used for indicating which first sound wave signal a respective second sound wave signal is a feedback to.

Correspondingly, a manner in which the underwater motion trajectory of the user is generated according to the first sound wave signal and the second sound wave signal may be that the underwater motion trajectory is generated according to the first sound wave signal, the second sound wave signal and the second identifier, where the second identifier includes at least part of information of the first identifier.

In an embodiment, to indicate that the second sound wave signal is a response to the first sound wave signal, the second identifier may include the at least part of the information of the first identifier. In an embodiment, the second identifier not only includes at least part of content of the first identifier but may also include information such as an identifier of the sonar device and/or a delay duration of the sonar device. The positioning of the first mobile terminal may be determined according to the first sound wave signal, the second sound wave signal and the information in the second identifier, and a continuous motion trajectory of the first mobile terminal over a certain period of time is determined according to the positioning of the first mobile terminal at different moments and used as the underwater motion trajectory of the user.

In some embodiments, the first mobile terminal includes a first display device, and the method for generating an underwater motion trajectory includes a step below.

The first mobile terminal is controlled to display the underwater motion trajectory on the first display device.

The first display device is a display device on the first mobile terminal, such as a screen. In an embodiment, after being generated, the underwater motion trajectory of the user may be displayed using the first display device for the user to view. If the first mobile terminal includes the first display device, the underwater motion trajectory of the user may be displayed on the first display device of the first mobile terminal.

In some embodiments, the sonar system further includes a second mobile terminal, the second mobile terminal includes a second display device, and the method for generating an underwater motion trajectory further includes the steps below.

The second mobile terminal is controlled to acquire the underwater motion trajectory. The second mobile terminal is controlled to display the underwater motion trajectory on the second display device.

The second mobile terminal may be a device having a display function, such as a smartwatch or a smart bracelet, where the second display device is included.

In an embodiment, the first sound wave signal may be sent using the first mobile terminal, and the underwater motion trajectory is then displayed using the second mobile terminal after the underwater motion trajectory of the user is generated. For example, the first mobile terminal may be a portable sound wave receiving and sending apparatus, the second mobile terminal may be a smartwatch, and the user may simultaneously wear the first mobile terminal and the second mobile terminal when engaging in underwater sports and independently perform a sound wave receiving and sending function and the motion trajectory display function, thereby reducing the power consumption of the second mobile terminal and increasing the lifetime of the second mobile terminal.

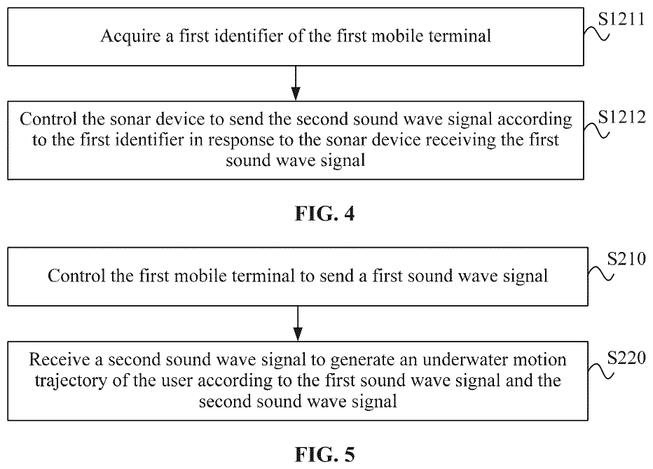

FIG. 5 is a flowchart of a method for generating an underwater motion trajectory according to an embodiment of the present application. This embodiment may record the underwater motion trajectory. The method may be performed by a first mobile terminal carried by a user in a sonar system. The sonar system may be implemented in the form of hardware and/or software. The sonar system further includes a sonar device located on the water surface. As shown in FIG. 5, the method includes the steps below.

In S210, the first mobile terminal is controlled to send a first sound wave signal.

The sonar device is a device that uses the propagation and reflection characteristics of sound waves in water to navigate and measure a distance through electro-acoustic conversion and information processing. The first mobile terminal is a mobile device having a sound wave sending function and may be carried by the user. The first sound wave signal may be a sound wave signal sent by the first mobile terminal.

In an embodiment, the first mobile terminal may be a device such as a smartwatch or a smart bracelet that integrates the sound wave sending function and a motion trajectory display function or may also be an independent mobile sound wave sending device. When the user is below the water surface, the first mobile terminal may send the first sound wave signal to the sonar device.

In S220, a second sound wave signal is received to generate an underwater motion trajectory of the user according to the first sound wave signal and the second sound wave signal.

The second sound wave signal is sent by the sonar device in response to the received first sound wave signal.

In an embodiment, after receiving the first sound wave signal, the sonar device sends the second sound wave signal in response to the first sound wave signal, and the first mobile terminal receives the second sound wave signal.

In an embodiment, the underwater motion trajectory of the user may be generated according to the first sound wave signal and the second sound wave signal, and the specific method is as described in the preceding embodiments.

In some embodiments, the first sound wave signal includes a first identifier of the first mobile terminal, and the method for generating an underwater motion trajectory further includes a step below.

The first identifier of the first mobile terminal is generated to control, in response to the sonar device receiving the first sound wave signal, the sonar device to send the second sound wave signal according to the first identifier.

In an embodiment, the first identifier may be generated before the first mobile terminal sends the first sound wave signal, and the first identifier may be at least one type of information among identification information such as an identifier of the first mobile terminal, a sending time of the first sound wave signal and an identifier of the first sound wave signal and may indicate to the sonar device that the first sound wave signal is sent by the first mobile terminal. After receiving the first sound wave signal, the sonar device may send the second sound wave signal according to the first identifier in the first sound wave signal.

In some embodiments, the second sound wave signal includes a second identifier of the sonar device, and the second identifier is configured to generate the underwater motion trajectory according to the first sound wave signal, the second sound wave signal and the second identifier.

The second identifier includes at least part of information of the first identifier.

In an embodiment, the second identifier is generated according to the first identifier and includes the at least part of the information of the first identifier to indicate to the first mobile terminal that the second sound wave signal is sent by the sonar device in response to the received first sound wave signal sent by the first mobile terminal.

In an embodiment, the second identifier not only includes at least part of content of the first identifier but may also include information such as an identifier of the sonar device and/or a delay duration of the sonar device. The positioning of the first mobile terminal may be determined according to the first sound wave signal, the second sound wave signal and the information in the second identifier, and a continuous motion trajectory of the first mobile terminal over a certain period of time is determined according to the positioning of the first mobile terminal at different moments and used as the underwater motion trajectory of the user.

In some embodiments, the first mobile terminal includes a first display device, and the method for generating an underwater motion trajectory includes a step below.

The underwater motion trajectory is acquired. The first mobile terminal is controlled to display the underwater motion trajectory on the first display device.

In an embodiment, after being generated, the underwater motion trajectory of the user may be displayed using the first display device for the user to view. If the first mobile terminal includes the first display device, the underwater motion trajectory of the user may be displayed on the first display device of the first mobile terminal.

In some embodiments, the method for generating an underwater motion trajectory further includes a step below.

The first mobile terminal is controlled to send the underwater motion trajectory to a second mobile terminal for display, where the second mobile terminal includes a second display device.

The second mobile terminal may be a device having a display function, such as a smartwatch or a smart bracelet, where the second display device is included.

In an embodiment, the first sound wave signal may be sent using the first mobile terminal, and the underwater motion trajectory is then displayed using the second mobile terminal after the underwater motion trajectory of the user is generated. For example, the first mobile terminal may be a portable sound wave receiving and sending apparatus, the second mobile terminal may be a smartwatch, and the user may simultaneously wear the first mobile terminal and the second mobile terminal when engaging in underwater sports and independently perform a sound wave receiving and sending function and the motion trajectory display function, thereby reducing the power consumption of the second mobile terminal and increasing the lifetime of the second mobile terminal.

An embodiment of the present application further provides a sonar system. The sonar system includes a first mobile terminal carried by a user and a sonar device located on the water surface. The sonar system further includes at least one processor. The at least one processor is configured to perform the steps below.

The first mobile terminal is controlled to send a first sound wave signal.

The sonar device is controlled to send a second sound wave signal in response to the sonar device receiving the first sound wave signal.

The first mobile terminal is controlled to generate an underwater motion trajectory of the user according to the first sound wave signal and the second sound wave signal.

In an embodiment, the at least one processor is further configured to acquire a first location of the sonar device and determine a second location of the first mobile terminal according to the first sound wave signal, the second sound wave signal and the first location.

When the step in which the underwater motion trajectory of the user is generated according to the first sound wave signal and the second sound wave signal is performed, the at least one processor is configured to generate the underwater motion trajectory according to the second location.

In an embodiment, the first location is collected by a positioning apparatus of the sonar device.

In an embodiment, the sonar device includes at least two sound wave sending apparatuses, and when the step in which the sonar device is controlled to send the second sound wave signal is performed, the at least one processor is configured to control the at least two sound wave sending apparatuses to send the second sound wave signal.

When the step in which the second location of the first mobile terminal is determined according to the first sound wave signal, the second sound wave signal and the first location is performed, the at least one processor is configured to determine a third location of each sound wave sending apparatus according to the first location and an installation location relationship of each sound wave sending apparatus on the sonar device; determine the second location according to the first sound wave signal, the second sound wave signal sent by the at least two sound wave sending apparatuses and the third locations of the at least two sound wave sending apparatuses.

In an embodiment, the sonar device includes at least two sound wave receiving apparatuses, the at least two sound wave receiving apparatuses are configured to receive the first sound wave signal, and when the step in which the sonar device is controlled to send the second sound wave signal in response to the sonar device receiving the first sound wave signal is performed, the at least one processor is configured to control the sonar device to send the second sound wave signal in response to any sound wave receiving apparatus receiving the first sound wave signal.

When the step in which the second location of the first mobile terminal is determined according to the first sound wave signal, the second sound wave signal and the first location is performed, the at least one processor is configured to determine a fourth location of each sound wave receiving apparatus according to the first location and an installation location relationship of each sound wave receiving apparatus on the sonar device; determine the second location of the first mobile terminal according to the first sound wave signal, the second sound wave signal and the fourth locations of the at least two sound wave receiving apparatuses.

In an embodiment, the sonar system includes at least two sonar devices, and the at least one processor is configured to control the at least two sonar devices to receive the first sound wave signal and send the second sound wave signal.

When the step in which the second location of the first mobile terminal is determined according to the first sound wave signal, the second sound wave signal and the first location is performed, the at least one processor is configured to determine the second location of the first mobile terminal according to the first sound wave signal, the second sound wave signal and first locations.

In an embodiment, the at least one processor is further configured to acquire a first sending time of the first sound wave signal and a second receiving time of the second sound wave signal.

When the step in which the underwater motion trajectory of the user is generated according to the first sound wave signal and the second sound wave signal is performed, the at least one processor is configured to determine the second location of the first mobile terminal according to the first sending time and the second receiving time; generate the underwater motion trajectory according to the second location.

In an embodiment, the at least one processor is further configured to acquire a delay duration of the sonar device, where the delay duration is determined by a first receiving time at which the sonar device receives the first sound wave signal and a second sending time at which the sonar device sends the second sound wave signal.

When the step in which the second location of the first mobile terminal is determined according to the first sending time and the second receiving time is performed, the at least one processor is configured to determine the second location of the first mobile terminal according to the first sending time, the second receiving time and the delay duration.

In an embodiment, the first sound wave signal includes a first identifier of the first mobile terminal, and the at least one processor is further configured to acquire the first identifier of the first mobile terminal.

When the step in which the sonar device is controlled to send the second sound wave signal in response to the sonar device receiving the first sound wave signal is performed, the at least one processor is configured to control the sonar device to send the second sound wave signal according to the first identifier in response to the sonar device receiving the first sound wave signal.

In an embodiment, the second sound wave signal includes a second identifier of the sonar device, and the at least one processor is configured to determine the second identifier according to the first identifier.

When the step in which the underwater motion trajectory of the user is generated according to the first sound wave signal and the second sound wave signal is performed, the at least one processor is configured to generate the underwater motion trajectory according to the first sound wave signal, the second sound wave signal and the second identifier, where the second identifier includes at least part of information of the first identifier.

In an embodiment, the first mobile terminal includes a first display device, and the at least one processor is further configured to control the first mobile terminal to display the underwater motion trajectory on the first display device.

In an embodiment, the sonar system further includes a second mobile terminal, the second mobile terminal includes a second display device, and the at least one processor is further configured to control the second mobile terminal to acquire the underwater motion trajectory; control the second mobile terminal to display the underwater motion trajectory on the second display device.

The sonar system provided in the embodiment of the present application may perform the method for generating an underwater motion trajectory provided in the embodiment of the present application, where the method is applied to the sonar system, and has functional modules and beneficial effects that correspond to the execution method.

An embodiment of the present application further provides a first mobile terminal of a sonar system. The first mobile terminal is carried by a user. The sonar system further includes a sonar device located on the water surface. The first mobile terminal includes at least one processor. The at least one processor is configured to control the first mobile terminal to send a first sound wave signal; receive a second sound wave signal to generate an underwater motion trajectory of the user according to the first sound wave signal and the second sound wave signal.

The second sound wave signal is sent by the sonar device in response to the received first sound wave signal.

In an embodiment, the first sound wave signal includes a first identifier of the first mobile terminal, and the at least one processor is further configured to generate the first identifier of the first mobile terminal to control, in response to the sonar device receiving the first sound wave signal, the sonar device to send the second sound wave signal according to the first identifier.

In an embodiment, the second sound wave signal includes a second identifier of the sonar device, and the second identifier is configured to generate the underwater motion trajectory according to the first sound wave signal, the second sound wave signal and the second identifier, where the second identifier includes at least part of information of the first identifier.

In an embodiment, the first mobile terminal includes a first display device, and the at least one processor is further configured to acquire the underwater motion trajectory; control the first mobile terminal to display the underwater motion trajectory on the first display device.

In an embodiment, the at least one processor is further configured to control the first mobile terminal to send the underwater motion trajectory to a second mobile terminal for display, where the second mobile terminal includes a second display device.

The first mobile terminal of the sonar system provided in the embodiment of the present application may perform the method for generating an underwater motion trajectory provided in the embodiment of the present application, where the method is applied to the first mobile terminal of the sonar system, and has functional modules and beneficial effects that correspond to the execution method.

The various embodiments of the systems and techniques described herein may be implemented in digital electronic circuitry, integrated circuitry, a field-programmable gate array (FPGA), an application-specific integrated circuit (ASIC), application specific standard parts (ASSP), a system on a chip (SoC), a complex programmable logic device (CPLD), computer hardware, firmware, software and/or a combination thereof. The various embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input apparatus and at least one output apparatus and transmitting data and instructions to the memory system, the at least one input apparatus and the at least one output apparatus.

Computer programs for implementation of the method of the present application may be written in one programming language or any combination of multiple programming languages. These computer programs may be provided for a processor of a general-purpose computer, a special-purpose computer or another programmable data processing apparatus such that the computer programs, when executed by the processor, cause functions/operations specified in the flowcharts and/or block diagrams to be implemented. These computer programs may be executed entirely on a machine, partly on a machine, as a stand-alone software package, partly on a machine and partly on a remote machine, or entirely on a remote machine or a server.

In the context of the present application, the non-transitory computer-readable storage medium may be a tangible medium including or storing a computer program that is used by or used in conjunction with an instruction execution system, apparatus, or device. The non-transitory computer-readable storage medium may include, but is not limited to, an electronic, magnetic, optical, electromagnetic, infrared or semiconductor system, apparatus or device, or any suitable combination thereof. Alternatively, the non-transitory computer-readable storage medium may be a machine-readable signal medium. More specific examples of the machine-readable storage medium include an electrical connection based on one or more wires, a portable computer disk, a hard disk, a random-access memory (RAM), a read-only memory (ROM), an erasable programmable read-only memory (EPROM), a flash memory, an optical fiber, a portable compact disk read-only memory (CD-ROM), an optical memory device, a magnetic memory device, or any suitable combination thereof.

The storage medium may be a non-transitory storage medium.

In order that interaction with the user is provided, the systems and techniques described herein may be implemented on an electronic device. The electronic device has a display device (for example, a cathode-ray tube (CRT) or a liquid-crystal display (LCD) monitor) for displaying information to the user, and a keyboard and a pointing apparatus (for example, a mouse or a trackball) through which the user can provide input for the electronic device. Other types of apparatuses may also be used for providing interaction with the user. For example, feedback provided for the user may be sensory feedback in any form (for example, visual feedback, auditory feedback, or tactile feedback); and input from the user may be received in any form (including acoustic input, voice input, or tactile input).

The systems and techniques described herein may be implemented in a computing system including a back-end component (for example, a data server), a computing system including a middleware component (for example, an application server), a computing system including a front-end component (for example, a user computer having a graphical user interface or a web browser through which the user can interact with embodiments of the systems and techniques described herein), or a computing system including any combination of such back-end, middleware, or front-end components. Components of a system may be interconnected by any form or medium of digital data communication (for example, a communication network). Examples of the communication network include a local area network (LAN), a wide area network (WAN), a blockchain network and the Internet.

The computing system may include clients and servers. A client and a server are generally remote from each other and typically interact through a communication network. The relationship between the client and the server arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in conventional physical host and virtual private server (VPS) services.

Embodiments of the present application provide a method for generating an underwater motion trajectory, a system, a terminal and a storage medium so as to record the underwater motion trajectory.

It is to be understood that various forms of the preceding flows may be used with steps reordered, added or deleted. For example, the steps described in the present application may be executed in parallel, in sequence or in a different order as long as the desired results of the embodiments of the present application can be achieved. The execution sequence of the steps is not limited herein.

The scope of the present application is not limited to the preceding embodiments. It is to be understood by those skilled in the art that various modifications, combinations, subcombinations and substitutions may be made according to design requirements and other factors. Any modifications, equivalent substitutions, improvements and the like made within the spirit and principle of the present application are within the scope of the present application.

What is claimed is:

1. A method for generating an underwater motion trajectory, the method being applied to a sonar system, wherein the sonar system comprises a first mobile terminal carried by a user and a sonar device located on a water surface; and the method comprising:
controlling the first mobile terminal to send a first sound wave signal;
controlling the sonar device to send a second sound wave signal in response to the sonar device receiving the first sound wave signal; and
controlling the first mobile terminal to generate an underwater motion trajectory of the user according to the first sound wave signal and the second sound wave signal.

2. The method of claim 1, further comprising:
controlling the first mobile terminal to acquire a first location of the sonar device; and
controlling the first mobile terminal to determine a second location of the first mobile terminal according to the first sound wave signal, the second sound wave signal and the first location,
wherein controlling the first mobile terminal to generate the underwater motion trajectory of the user according to the first sound wave signal and the second sound wave signal comprises:
controlling the first mobile terminal to generate the underwater motion trajectory according to the second location.

3. The method of claim 2, wherein the first location is collected by a positioning apparatus of the sonar device.

4. The method of claim 2, wherein the sonar device comprises at least two sound wave sending apparatuses, and controlling the sonar device to send the second sound wave signal comprises:
controlling the at least two sound wave sending apparatuses to send the second sound wave signal,
wherein controlling the first mobile terminal to determine the second location of the first mobile terminal according to the first sound wave signal, the second sound wave signal and the first location comprises:
controlling the first mobile terminal to determine a third location of each of the at least two sound wave sending apparatuses according to the first location and an installation location relationship of each of the at least two sound wave sending apparatuses on the sonar device; and
controlling the first mobile terminal to determine the second location according to the first sound wave signal, the second sound wave signal sent by the at least two sound wave sending apparatuses and the third locations of the at least two sound wave sending apparatuses.

5. The method of claim 2, wherein the sonar device comprises at least two sound wave receiving apparatuses, wherein the at least two sound wave receiving apparatuses are configured to receive the first sound wave signal, and controlling the sonar device to send the second sound wave signal in response to the sonar device receiving the first sound wave signal comprises:
controlling the sonar device to send the second sound wave signal in response to one of the at least two sound wave receiving apparatuses receiving the first sound wave signal,
wherein controlling the first mobile terminal to determine the second location of the first mobile terminal according to the first sound wave signal, the second sound wave signal and the first location comprises:
controlling the first mobile terminal to determine a fourth location of each of the at least two sound wave receiving apparatuses according to the first location and an installation location relationship of each of the at least two sound wave receiving apparatuses on the sonar device; and
controlling the first mobile terminal to determine the second location of the first mobile terminal according to the first sound wave signal, the second sound wave signal and the fourth locations of the at least two sound wave receiving apparatuses.

6. The method of claim 2, wherein the sonar system comprises at least two sonar devices, and the method further comprises:
controlling the at least two sonar devices to receive the first sound wave signal and send the second sound wave signal,
wherein controlling the first mobile terminal to determine the second location of the first mobile terminal according to the first sound wave signal, the second sound wave signal and the first location comprises:
controlling the first mobile terminal to determine the second location of the first mobile terminal according to the first sound wave signal, the second sound wave signal and first locations of the at least two sonar devices.

7. The method of claim 1, further comprising:
controlling the first mobile terminal to acquire a first sending time of the first sound wave signal and a second receiving time of the second sound wave signal,
wherein controlling the first mobile terminal to generate the underwater motion trajectory of the user according to the first sound wave signal and the second sound wave signal comprises:
controlling the first mobile terminal to determine a second location of the first mobile terminal according to the first sending time and the second receiving time; and
controlling the first mobile terminal to generate the underwater motion trajectory according to the second location.

8. The method of claim 7, further comprising:
controlling the first mobile terminal to acquire a delay duration of the sonar device, wherein the delay duration is determined by a first receiving time at which the sonar device receives the first sound wave signal and a second sending time at which the sonar device sends the second sound wave signal,
wherein controlling the first mobile terminal to determine the second location of the first mobile terminal according to the first sending time and the second receiving time comprises:
controlling the first mobile terminal to determine the second location of the first mobile terminal according to the first sending time, the second receiving time and the delay duration.

9. The method of claim 1, wherein the first sound wave signal comprises a first identifier of the first mobile terminal, and the method further comprises:
controlling the sonar device to acquire the first identifier of the first mobile terminal,
wherein controlling the sonar device to send the second sound wave signal in response to the sonar device receiving the first sound wave signal comprises:
controlling the sonar device to send the second sound wave signal according to the first identifier in response to the sonar device receiving the first sound wave signal.

10. The method of claim 9, wherein the second sound wave signal comprises a second identifier of the sonar device, and the method further comprises:
controlling the sonar device to determine the second identifier according to the first identifier,
wherein controlling the first mobile terminal to generate the underwater motion trajectory of the user according to the first sound wave signal and the second sound wave signal comprises:
controlling the first mobile terminal to generate the underwater motion trajectory according to the first sound wave signal, the second sound wave signal and the second identifier,
wherein the second identifier comprises at least part of information of the first identifier.

11. The method of claim 1, wherein the first mobile terminal comprises a first display device, and the method further comprises:
controlling the first mobile terminal to display the underwater motion trajectory on the first display device.

12. The method of claim 1, wherein the sonar system further comprises a second mobile terminal, wherein the second mobile terminal comprises a second display device; and the method further comprises:
controlling the second mobile terminal to acquire the underwater motion trajectory; and
controlling the second mobile terminal to display the underwater motion trajectory on the second display device.

13. A method for generating an underwater motion trajectory, the method being applied to a first mobile terminal carried by a user in a sonar system, wherein the sonar system further comprises a sonar device; and the method comprising:
controlling the first mobile terminal to send a first sound wave signal; and
receiving a second sound wave signal to generate an underwater motion trajectory of the user according to the first sound wave signal and the second sound wave signal,
wherein the second sound wave signal is sent by the sonar device in response to the received first sound wave signal.

14. The method of claim 13, wherein the first sound wave signal comprises a first identifier of the first mobile terminal, and the method further comprises:
generating the first identifier of the first mobile terminal, wherein in response to the sonar device receiving the first sound wave signal, the sonar device sends the second sound wave signal according to the first identifier.

15. The method of claim 14, wherein the second sound wave signal comprises a second identifier of the sonar device, wherein the second identifier of the sonar device is configured to generate the underwater motion trajectory according to the first sound wave signal, the second sound wave signal and the second identifier,
wherein the second identifier comprises at least part of information of the first identifier.

16. The method of claim 13, wherein the first mobile terminal comprises a first display device, and the method further comprises:
acquiring the underwater monitor trajectory; and
controlling the first mobile terminal to display the underwater motion trajectory on the first display device,
wherein the method further comprises:
controlling the first mobile terminal to send the underwater motion trajectory to a second mobile terminal for display, wherein the second mobile terminal comprises a second display device.

17. A sonar system, comprising a first mobile terminal carried by a user and a sonar device located on a water surface and further comprising at least one processor, wherein the at least one processor is configured to perform the following steps:
controlling the first mobile terminal to send a first sound wave signal;
controlling the sonar device to send a second sound wave signal in response to the sonar device receiving the first sound wave signal; and
controlling the first mobile terminal to generate an underwater motion trajectory of the user according to the first sound wave signal and the second sound wave signal.

18. A first mobile terminal of a sonar system, wherein the first mobile terminal is carried by a user, the sonar system further comprises a sonar device located on a water surface, and the first mobile terminal comprises at least one processor, wherein the at least one processor is configured to perform the method for generating an underwater motion trajectory according to claim 13.

19. A non-transitory computer-readable storage medium storing computer instructions which, when executed by a processor, are configured to cause the processor to perform the method for generating an underwater motion trajectory according to claim 1.

20. A non-transitory computer-readable storage medium storing computer instructions which, when executed by a processor, are configured to cause the processor to perform the method for generating an underwater motion trajectory according to claim 13.
